(19) United States
(12) Patent Application Publication
(10) Pub. No.: US 2018/0010982 A1
(43) Pub. Date: Jan. 11, 2018

(54) ENGINE PERFORMANCE MODELING BASED ON WASH EVENTS

(71) Applicant: GE Aviation Systems LLC, Grand Rapids, MI (US)

(72) Inventors: David Geoffrey Dauenhauer, Cincinnati, OH (US); Ronald Matthew DiMuro, Loveland, OH (US); Brian William Pfeiffer, Liberty Township, OH (US); Rob Anthony, Mason, OH (US); Adam Joseph Schroeder, Cincinnati, OH (US)

(21) Appl. No.: 15/642,790

(22) Filed: Jul. 6, 2017

Related U.S. Application Data
(60) Provisional application No. 62/359,980, filed on Jul. 8, 2016.

(51) Int. Cl. G01M 15/10; F01D 25/00; F02C 3/04

(52) U.S. Cl. CPC G01M 15/102; F01D 25/002; F02C 3/04; F05D 2270/303; F05D 2220/323

(57) ABSTRACT

One example aspect of the present disclosure is directed to a method for measuring engine performance. The method includes receiving first parameters related to engine performance prior to an engine wash event. The method includes receiving second parameters related to engine performance after the engine wash event. The method includes determining an engine performance prior to the engine wash event based on the first parameters. The method includes determining an engine performance after the engine wash event based on the second parameters. The method includes determining an effectiveness of the engine wash event based on the engine performance prior to the engine wash event and the engine performance after the engine wash event.

### PRIORITY CLAIM

The present application claims the benefit of priority of U.S. Provisional Patent Application No. 62/359,980, entitled “ ENGINE PERFORMANCE MODELING BASED ON WASH EVENTS,” filed Jul. 8, 2016, which is incorporated herein by reference for all purposes.

### FIELD

The present subject matter relates generally to aerial vehicles.

### BACKGROUND

An aerial vehicle can rely on one or more engines to control the aerial vehicle. Engine performance can be affected by cleanliness of the engine. Washing the engine regularly can improve the performance of the engine and extend the life of the engine. However, washing the engine unnecessarily can waste resources. It can be difficult to manage a wash program without a clear measurement of the effectiveness of each engine wash.

### BRIEF DESCRIPTION

Aspects and advantages of embodiments of the present disclosure will be set forth in part in the following description, or may be learned from the description, or may be learned through practice of the embodiments.

One example aspect of the present disclosure is directed to a method for measuring engine performance. The method includes receiving first parameters related to engine performance prior to the engine wash event. The method includes receiving second parameters related to engine performance after the engine wash event. The method includes determining an engine performance prior to the engine wash event based on the first parameters. The method includes determining an engine performance after the engine wash event based on the second parameters. The method includes determining an effectiveness of the engine wash event based on the engine performance prior to the engine wash event and the engine performance after the engine wash event.

Another example aspect of the present disclosure is directed to a system. The system includes one or more memory devices. The system includes one or more processors. The one or more processors are configured to receive first parameters related to engine performance prior to the engine wash event. The one or more processors are configured to receive second parameters related to engine performance after the engine wash event. The one or more processors are configured to determine an engine performance prior to the engine wash event based on the first parameters. The one or more processors are configured to determine an engine performance after the engine wash event based on the second parameters. The one or more processors are configured to determine an effectiveness of the engine wash event based on the engine performance prior to the engine wash event and the engine performance after the engine wash event.

Other example aspects of the present disclosure are directed to systems, methods, aerial vehicles, avionics systems, devices, non-transitory computer-readable media for measuring engine performance. Variations and modifications can be made to these example aspects of the present disclosure.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an aerial vehicle according to example embodiments of the present disclosure;

FIG. 2 depicts a flow diagram of an example method according to example embodiments of the present disclosure;

FIG. 3 depicts a flow diagram of an example method according to example embodiments of the present disclosure;

FIG. 4 depicts a flow diagram of an example method according to example embodiments of the present disclosure;

FIG. 5 depicts a computing system for implementing one or more aspects according to example embodiments of the present disclosure; and

FIG. 6 depicts an example interface according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the embodiments. In fact, it will be apparent to those skilled in the art that various modifications and variations can be made in the present disclosure without departing from the scope or spirit of the invention. For instance, features illustrated or described as part of one embodiment can be used with another embodiment to yield a still further embodiment. Thus, it is intended that the present disclosure covers such modifications and variations as come within the scope of the appended claims and their equivalents.

As used in the specification and the appended claims, the singular forms “a,” “an,” and “the” include plural referents unless the context clearly dictates otherwise. The use of the term “about” in conjunction with a numerical value refers to within 25% of the stated amount.

Example aspects of the present disclosure are directed to methods and systems that can measure engine performance. The aerial vehicle can transmit (e.g., deliver, send, etc.) parameters to a ground system. The parameters can include and/or can be used to determine Exhaust Gas Temperature (EGT), EGT Hot Day Margin (EGTHDM), fuel burn, modular efficiency, other analytic measures of engine performance, the like, and/or any combination of the foregoing. The parameters can be collected as a part of normal operation of the aerial vehicle even in the absence of the systems and methods according to the present disclosure.

When an engine is washed, one or more attributes related to the wash can be determined (e.g., recorded, measured, calculated, etc.). The one or more engine wash attributes can include one or more of the following: a wash date, a wash time, a wash station, a washer, a washer skill level, a worker experience level, a worker training level, a number of washers, an engine, a fleet, a number of wash cycles, a total dissolved solvents measurement at each cycle, a total suspended solvents measurement at each cycle, a number of rinses, a total dissolved solids, an equipment type, and/or other relevant attributes to a defined wash procedure.

Parameters related to a threshold number of flights before the engine wash can be analyzed (e.g., examined, studied, etc.). In an embodiment, the parameters before the wash can be plotted on a graph to determine a decline in engine performance. In an embodiment, a first regression line for projecting a decline in engine performance can be created based on the graph. Parameters related to a threshold number of flights after the engine wash can be analyzed. In an embodiment, the parameters after the wash can be plotted to on a graph to determine a decline in engine performance. In an embodiment, a second regression line for projecting a decline in engine performance can be created based on the graph.

The effectiveness of the engine wash can be determined by analyzing the parameter before the engine wash and the parameters after the engine wash. In an embodiment, the first regression line can be compared with the second regression line. The difference in the first regression line and the second regression line can be considered a reduction in the decline in engine performance attributable to the engine wash.

The effectiveness of engine washes can be aggregated and analyzed. For instance, as one example, the engine washes of a single engine can be aggregated. As another example, the engine washes of engines on a single aerial vehicle can be aggregated. As another example, the engine washes of engine in a fleet can be aggregated.

The engine washes can be categorized and analyzed by attributes. For example, the engine washes with one washer can be sorted into one category; engine washes with two washers can be sorted into another category; etc. In the example, the cost of adding washers to a wash can be analyzed in light of the effectiveness of the wash by adding a washer. In the example, a desired number of washers per wash can be determined. Similar analysis can be performed for the other one or more attributes. Trends can be determined among one or more of the attributes.

In this way, the systems and methods according to example aspects of the present disclosure have a technical effect of measuring how engine washes affect engine performance.

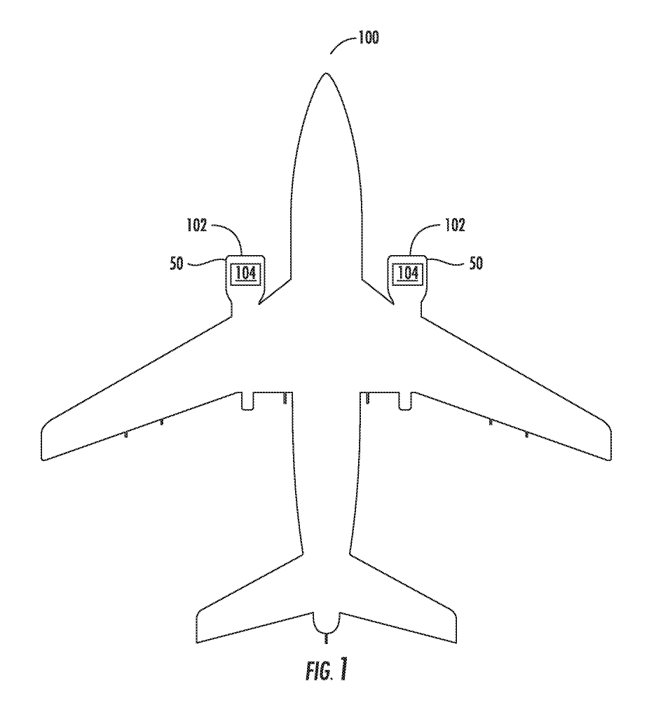

FIG. 1 depicts a block diagram of an aerial vehicle 100 according to example embodiments of the present disclosure. The aerial vehicle 100 can include one or more engines 102. The one or more engines 102 can cause operations, such as propulsion, of the aerial vehicle 100. An engine 102 can include a nacelle 50 for housing components. An engine 102 can be a gas turbine engine. A gas turbine engine can include a fan and a core arranged in flow communication with one another. Additionally, the core of the gas turbine engine generally includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gases through the turbine section drives the turbine section and is then routed through the exhaust section, e.g., to atmosphere.

The one or more engines 102 can include and/or be in communication with one or more electronic engine controllers (EECs) 104. The one or more EECs 104 can record data related to the one or more engines 102.

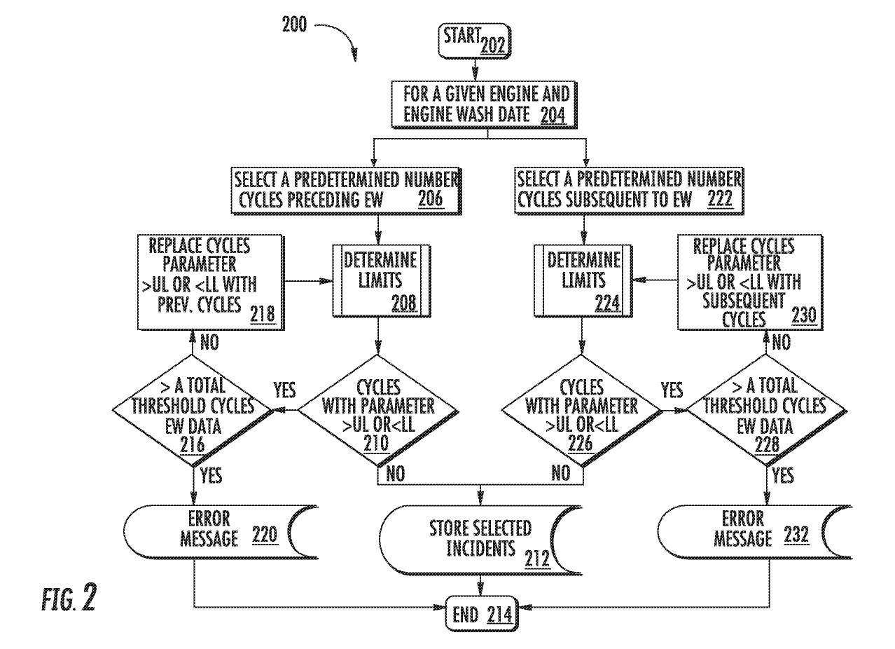

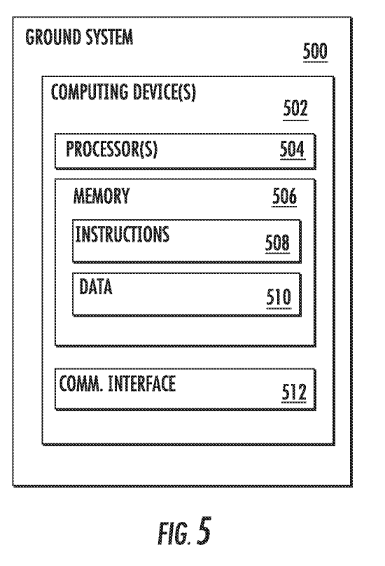

FIG. 2 depicts a flow diagram of an example method 200 for calculating engine wash effectiveness. The method of FIG. 2 can be implemented using, for instance, the one or more computing devices 502 of the ground system 500 of FIG. 5. FIG. 2 depicts steps performed in a particular order for purposes of illustration and discussion. Those of ordinary skill in the art, using the disclosures provided herein, will understand that various steps of any of the methods disclosed herein can be adapted, rearranged, or modified in various ways without deviating from the scope of the present disclosure.

At (202), the method 200 can start. For instance, the one or more computing devices 502 of the ground system 500 can start the method 200. At (204), an engine wash event associated with an engine for which the effectiveness will be determined can be selected (e.g., determined, etc.). For instance, the one or more computing devices 502 of the ground system 500 can select an engine wash event associated with an engine for which the effectiveness will be determined.

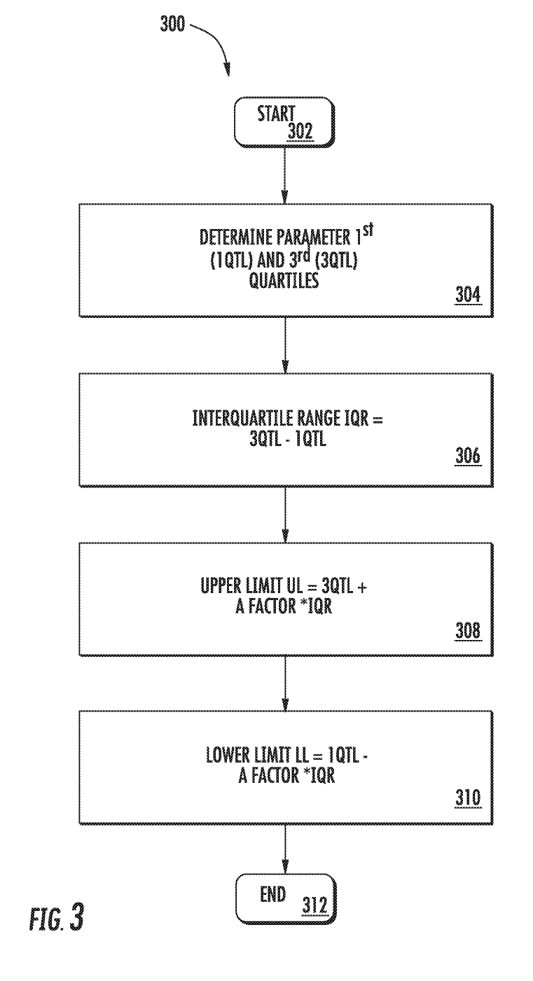

At (206), a predetermined number of incidents preceding the engine wash event can be selected. For instance, the one or more computing devices 502 of the ground system 500 can select a predetermined number of incidents preceding the engine wash event. In an embodiment, the incidents can be flights, engine power cycles, points of data captured at any frequency and/or the like. In an embodiment, the predetermined number of incidents preceding the engine wash event can be 20. In other embodiments, the predetermined number of incidents preceding the engine wash event can be any other number. At (208), limits can be determined. For instance, the one or more computing devices 502 of the ground system 500 can determine limits. The determined limits include an upper limit and a lower limit. The determined limits can be determined for one or more parameters related to engine performance. The one or more parameters related to engine performance can include Exhaust Gas Temperature (EGT), EGT Hot Day Margin (EGTHDM), fuel burn, modular efficiency, other analytic measures of engine performance, the like, and/or any combination of the foregoing. A method for determining limits will be described in more detail in FIG. 3 below.

At (210), a determination can be made of if the selected incidents include any incidents with a parameter above the upper limit or a parameter below the lower limit. For instance, the one or more computing devices 502 of the ground system 500 can determine if the selected incidents include any incidents with a parameter above the upper limit or a parameter below the lower limit. If not, then the method 200 can move to (212) and data for all of the selected incidents can be stored (e.g., load, record, etc.) to be used in analysis. For instance, the one or more computing devices 502 of the ground system 500 can store data for all of the selected incidents. After (212), the method 200 can move to (214) and end. For instance, the one or more computing devices 502 of the ground system 500 can end the method 200.

If the selected incidents include any incidents with a parameter above the upper limit or a parameter below the lower limit, the method can move to (216) and a total number of incidents considered can be compared against a total threshold. For instance, the one or more computing devices 502 of the ground system 500 can compare a total number of incidents considered against a total threshold. In an embodiment, the total threshold can be 30. In other embodiments, the total threshold can be any other number. If the total number of incidents is less than the total threshold, then the method 200 can move to (218) and the incidents with parameters below the lower limit or above the upper limit can be replaced with other previous incidents. For instance, the one or more computing devices 502 of the ground system 500 can replace the incidents with parameters below the lower limit or above the upper limit with other previous incidents. After (218), the method 200 can move to (208). If the total number of incidents is equal to or greater than the total threshold, then the method 200 can move to (220) and an error message can be generated. For instance, the one or more computing devices 502 of the ground system 500 can generate an error message. After (220), the method can move to (214).

At (222), a predetermined number of incidents subsequent to the engine wash event can be selected. For instance, the one or more computing devices 502 of the ground system 500 can select a predetermined number of incidents subsequent to the engine wash event. In an embodiment, the incidents can be flights, engine power cycles, and/or the like. In an embodiment, the predetermined number of incidents subsequent to the engine wash event can be 20. In other embodiments, the predetermined number of incidents subsequent to the engine wash event can be any other number. At (224), limits can be determined. For instance, the one or more computing devices 502 of the ground system 500 can determine limits. The determined limits include an upper limit and a lower limit. The determined limits can be determined for one or more parameters related to engine performance. The one or more parameters related to engine performance can include Exhaust Gas Temperature (EGT), EGT Hot Day Margin (EGTHDM), fuel burn, modular efficiency, other analytic measures of engine performance, the like, and/or any combination of the foregoing. A method for determining limits will be described in more detail in FIG. 3 below.

At (226), a determination can be made of if the selected incidents include any incidents with a parameter above the upper limit or a parameter below the lower limit. For instance, the one or more computing devices 502 of the ground system 500 can determine if the selected incidents include any incidents with a parameter above the upper limit or a parameter below the lower limit. If not, then the method 200 can move to (212) and data for all of the selected incidents can be stored (e.g., load, record, etc.) to be used in analysis. For instance, the one or more computing devices 502 of the ground system 500 can store data for all of the selected incidents. After (212), the method 200 can move to (214) and end. For instance, the one or more computing devices 502 of the ground system 500 can end the method 200.

If the selected incidents include any incidents with a parameter above the upper limit or a parameter below the lower limit, the method can move to (228) and a total number of incidents considered can be compared against a total threshold. For instance, the one or more computing devices 502 of the ground system 500 can compare a total number of incidents considered against a total threshold. In an embodiment, the total threshold can be 30. In other embodiments, the total threshold can be any other number. If the total number of incidents is less than the total threshold, then the method 200 can move to (230) and the incidents with parameters below the lower limit or above the upper limit can be replaced with other subsequent incidents. For instance, the one or more computing devices 502 of the ground system 500 can replace the incidents with parameters below the lower limit or above the upper limit with other subsequent incidents. After (230), the method 200 can move to (224). If the total number of incidents is equal to or greater than the total threshold, then the method 200 can move to (232) and an error message can be generated. For instance, the one or more computing devices 502 of the ground system 500 can generate an error message. After (232), the method can move to (214).

FIG. 3 depicts a flow diagram of an example method 300 for determining limits at (208) and/or (224). The method of FIG. 3 can be implemented using, for instance, the one or more computing devices 502 of the ground system 500 of FIG. 5. FIG. 3 depicts steps performed in a particular order for purposes of illustration and discussion. Those of ordinary skill in the art, using the disclosures provided herein, will understand that various steps of any of the methods disclosed herein can be adapted, rearranged, or modified in various ways without deviating from the scope of the present disclosure.

At (302), the method 300 can start. For instance, the one or more computing devices 502 of the ground system 500 can start the method 300. The method can be executed (run, etc.) for any of the one or more parameters related to engine performance including Exhaust Gas Temperature (EGT), EGT Hot Day Margin (EGTHDM), fuel burn, modular efficiency, other analytic measures of engine performance, the like, and/or any combination of the foregoing. For example, the method 300 can be run for EGTHDM for one or more incidents. At (304), a first quartile and a third quartile can be determined. For instance, the one or more computing devices 502 of the ground system 500 can determine a first quartile and a third quartile. For example, an EGTHDM first quartile and an EGTHDM third quartile can be determined.

At (306), an interquartile range can be determined. For instance, the one or more computing devices 502 of the ground system 500 can determine an interquartile range. The interquartile range can be determined by subtracting the determined first quartile from the determined third quartile. For example, an EGTHDM first quartile can be subtracted from the EGTHDM third quartile.

At (308), an upper limit can be determined. For instance, the one or more computing devices 502 of the ground system 500 can determine an upper limit. The interquartile range can be multiplied by a factor and added to the third quartile. For example, the factor can be 1.5. In other embodiments, the factor can be any other value. As a further example, the determined interquartile range can be multiplied by the factor and the result can be added to the EGTHDM third quartile to determine the upper limit. Incidents with a parameter having a value above the upper limit can be considered an outlier.

At (310), a lower limit can be determined. For instance, the one or more computing devices 502 of the ground system 500 can determine a lower limit. The interquartile range can be multiplied by a factor and subtracted from the first quartile. For example, the factor can be 1.5. In other embodiments, the factor can be any other value. As a further example, the determined interquartile range can be multiplied by the factor and the result can be subtracted from the EGTHDM first quartile to determine the lower limit. Incidents with a parameter having a value below the lower limit can be considered an outlier. At (312), the method 300 can end. For instance, the one or more computing devices 502 of the ground system 500 can end the method 300.

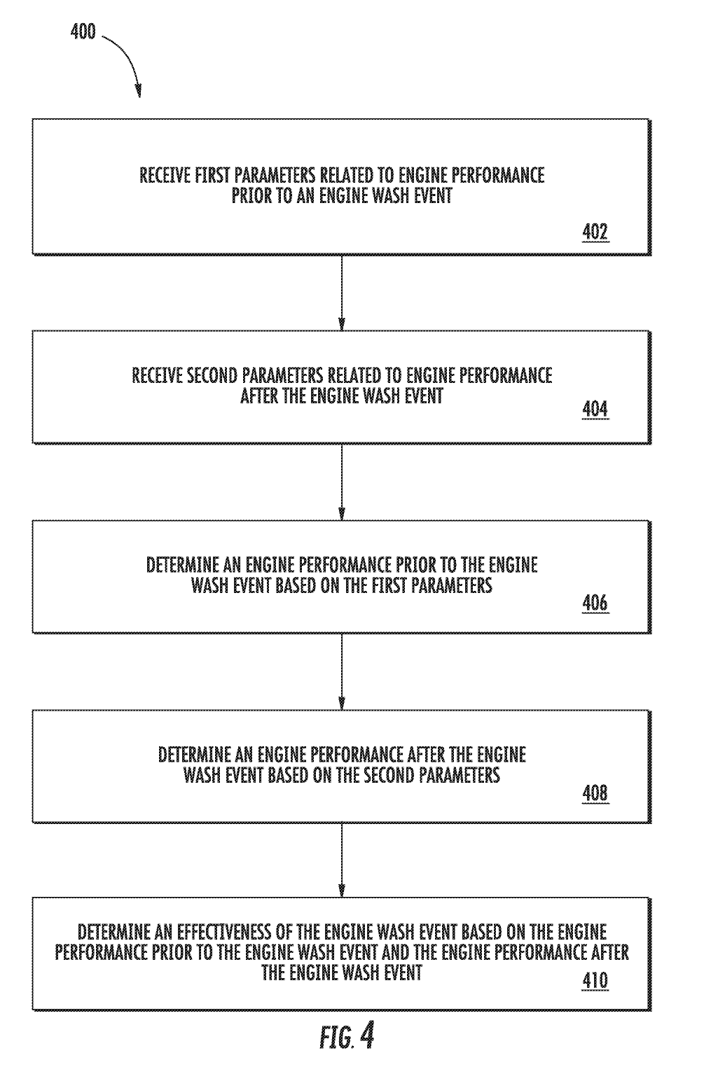

FIG. 4 depicts a flow diagram of an example method 400 for measuring engine performance. The method of FIG. 4 can be implemented using, for instance, the one or more computing devices 502 of the ground system 500 of FIG. 5. FIG. 4 depicts steps performed in a particular order for purposes of illustration and discussion. Those of ordinary skill in the art, using the disclosures provided herein, will understand that various steps of any of the methods disclosed herein can be adapted, rearranged, or modified in various ways without deviating from the scope of the present disclosure.

At (402), first parameters related to engine performance prior to an engine wash event can be received. For instance, the one or more computing devices 502 of the ground system 500 can receive first parameters related to engine performance prior to an engine wash event. For example, the first parameters can be received via a wireless communication between a server on the aerial vehicle 100 and the one or more computing devices 502 of the ground system 500. The parameters can include and/or can be used to determine Exhaust Gas Temperature (EGT), EGT Hot Day Margin (EGTHDM), fuel burn, modular efficiency, other analytic measures of engine performance, the like, and/or any combination of the foregoing. Optionally, environmental data can be received. For instance, the one or more computing devices 502 of the ground system 500 can receive environmental data. The environmental data can include, for example, data indicative of a dust storm, an ice storm, etc. The environmental data can be used to determine if an engine may need an engine wash event earlier than a regular schedule would indicate. An engine wash event can be scheduled based on the environmental data. In an embodiment, when engine performance has degraded below a threshold level and no engine wash event has been performed within a threshold window, a time based reminder can be generated and provided to a user. The time based reminder can include a reminder to schedule and/or perform an engine wash event.

Optionally, an indication of an engine wash event can be received. For instance, the one or more computing devices 502 of the ground system 500 can receive an indication of an engine wash event. Optionally, one or more engine wash event attributes can be received. For instance, the one or more computing devices 502 of the ground system 500 can receive one or more engine wash event attributes. The one or more engine wash event attributes can include one or more of the following: a wash date, a wash time, a wash station, a washer, a washer skill level, a worker experience level, a worker training level, a number of washers, an engine, a fleet, a number of wash cycles, a total dissolved solvents measurement at each cycle, a total suspended solvents measurement at each cycle, a number of rinses, a total dissolved solids, an equipment type, and/or other relevant attributes to a defined wash procedure. In an embodiment, the engine wash event can include a specific value and/or a value within a specific range of values for one or more engine wash event attributes. The specific value and/or the specific range of values can be customizable. The specific value and/or the specific range of values can be based on engine specific information. For example, one type of engine may require that engine wash events include a wash time of at least 30 minutes. In an embodiment, the engine wash event attributes of a plurality of engine wash events can be analyzed and form a basis for a recommendation for one or more engine wash event attributes for a future engine wash event.

At (404), second parameters related to engine performance after the engine wash event can be received. For instance, the one or more computing devices 502 of the ground system 500 can receive second parameters related to engine performance after the engine wash event. For example, the second parameters can be received via a wireless communication between a server on the aerial vehicle 100 and the one or more computing devices 502 of the ground system 500. The parameters can include and/or can be used to determine Exhaust Gas Temperature (EGT), EGT Hot Day Margin (EGTHDM), fuel burn, modular efficiency, other analytic measures of engine performance, the like, and/or any combination of the foregoing. The first parameters can be received before the indication of the engine wash event. The second parameters can be received after the indication of the engine wash event.

At (406), an engine performance prior to the engine wash event can be determined based on the first parameters. For instance, the one or more computing devices 502 of the ground system 500 can determine an engine performance prior to the engine wash event based on the first parameters. In an embodiment, determining an engine performance prior to the engine wash event based on the first parameters can include generating a first regression line, average, or other statistical measurement based on a first scatter plot, wherein one or more of the first parameters are used to create at least one point in the first scatter plot. In an embodiment, generating a first regression line, average, or other statistical measurement based on a first scatter plot can include removing one or more outlier points from the first scatter plot.

At (408), an engine performance after the engine wash event can be determined based on the second parameters. For instance, the one or more computing devices 502 of the ground system 500 can determine an engine performance after the engine wash event based on the second parameters. In an embodiment, determining an engine performance after the engine wash event based on the second parameters can include generating a second regression line, average, or other statistical measurement based on a second scatter plot, wherein one or more of the second parameters are used to create at least one point in the second scatter plot. In an embodiment, generating a second regression line, average, or other statistical measurement based on a second scatter plot can include removing one or more outlier points from the second scatter plot.

At (410), an effectiveness of the engine wash event can be determined based on the engine performance prior to the engine wash event and the engine performance after the engine wash event. For instance, the one or more computing devices 502 of the ground system 500 can determine an effectiveness of the engine wash event based on the engine performance prior to the engine wash event and the engine performance after the engine wash event. In an embodiment, the effectiveness of the engine wash event can be compared with an expected effectiveness of the engine wash event. When the effectiveness of the engine wash event does not compare favorably with (for example, is not within a threshold range of) the expected effectiveness, a notification can be created and provided to a user. In an embodiment, determining an effectiveness of the engine wash event can include categorizing the engine wash event into at least one category based, at least in part, on the one or more engine wash event attributes. In an embodiment, determining an effectiveness of the engine wash event can include comparing the first regression line, average, or other statistical measurement with the second regression line, average, or other statistical measurement.

Optionally, third parameters related to engine performance prior to a second wash event can be received. For instance, the one or more computing devices 502 of the ground system 500 can receive third parameters related to engine performance prior to a second wash event. For example, the third parameters can be received via a wireless communication between a server on the aerial vehicle 100 and the one or more computing devices 502 of the ground system 500. An indication of a second engine wash event can be received. For instance, the one or more computing devices 502 of the ground system 500 can receive an indication of a second engine wash event. Fourth parameters related to engine performance after the second engine wash event can be received. For instance, the one or more computing devices 502 of the ground system 500 can receive fourth parameters related to engine performance after the second engine wash event. For example, the fourth parameters can be received via a wireless communication between a server on the aerial vehicle 100 and the one or more computing devices 502 of the ground system 500. An engine performance prior to the second engine wash event can be determined based on the third parameters. For instance, the one or more computing devices 502 of the ground system 500 can determine an engine performance prior to the second engine wash event based on the third parameters. An engine performance after the second engine wash event can be determined based on the fourth parameters. For instance, the one or more computing devices 502 of the ground system 500 can determine an engine performance after the second engine wash event based on the fourth parameters. An effectiveness of the second engine wash event can be determined based on the engine performance prior to the second engine wash event and the engine performance after the second engine wash event. For instance, the one or more computing devices 502 of the ground system 500 can determine an effectiveness of the second engine wash event based on the engine performance prior to the second engine wash event and the engine performance after the second engine wash event. In an embodiment, an effectiveness of any number of engine wash events can be determined based on any number of parameters before and after the engine wash events. In an embodiment, a group of parameters before and after wash events can be used to analyze all wash events.

Optionally, the effectiveness of engine wash events can be modeled based, at least in part, on the effectiveness of the first engine wash event and the effectiveness of the second engine wash event. The effectiveness of engine wash events can be modeled based, at least in part, on the effectiveness of the first engine wash event. The model can be revised based, at least in part, on the effectiveness of the second engine wash event.

FIG. 5 depicts a block diagram of an example computing system that can be used to implement the ground system 500 or other systems of the aerial vehicle according to example embodiments of the present disclosure. As shown, the ground system 500 can include one or more computing device(s) 502. The one or more computing device(s) 502 can include one or more processor(s) 504 and one or more memory device(s) 506. The one or more processor(s) 504 can include any suitable processing device, such as a microprocessor, microcontroller, integrated circuit, logic device, or other suitable processing device. The one or more memory device(s) 506 can include one or more computer-readable media, including, but not limited to, non-transitory computer-readable media, RAM, ROM, hard drives, flash drives, or other memory devices.

The one or more memory device(s) 506 can store information accessible by the one or more processor(s) 504, including computer-readable instructions 508 that can be executed by the one or more processor(s) 504. The instructions 508 can be any set of instructions that when executed by the one or more processor(s) 504, cause the one or more processor(s) 504 to perform operations. The instructions 508 can be software written in any suitable programming language or can be implemented in hardware. In some embodiments, the instructions 508 can be executed by the one or more processor(s) 504 to cause the one or more processor(s) 504 to perform operations, such as the operations for measuring engine performance, as described with reference to FIGS. 2-4, and/or any other operations or functions of the one or more computing device(s) 502.

The memory device(s) 506 can further store data 510 that can be accessed by the processors 504. For example, the data 510 can include a navigational database, environmental database, data associated with the navigation system(s), data associated with the control mechanisms, data indicative of a flight plan associated with the vehicle 100, data associated with flight director mode selection, data associated with a flight management system, and/or any other data associated with vehicle 100, as described herein. The data 510 can include one or more table(s), function(s), algorithm(s), model(s), equation(s), etc. for measuring engine performance according to example embodiments of the present disclosure.

The one or more computing device(s) 502 can also include a communication interface 512 used to communicate, for example, with the other components of system. The communication interface 512 can include any suitable components for interfacing with one or more network(s), including for example, transmitters, receivers, ports, controllers, antennas, or other suitable components.

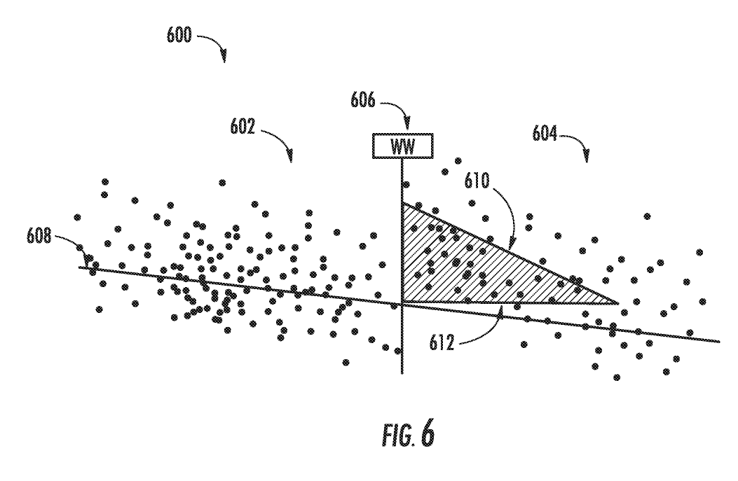

FIG. 6 depicts an example interface 600 according to example embodiments of the present disclosure. For instance, the one or more computing devices 502 of the ground system 500 can output the interface 600. The interface 600 can represent a graph wherein time is represented along a horizontal axis and a parameter for engine performance is represented along a vertical axis. The parameter related to engine performance can include Exhaust Gas Temperature (EGT), EGT Hot Day Margin (EGTHDM), fuel burn, modular efficiency, other analytic measures of engine performance, the like, and/or any combination of the foregoing. The interface 600 can include a first scatterplot 602 and a second scatterplot 604. A vertical line 606 can represent a time when a subject engine wash event occurred. The first scatterplot 602 can reside to the left of the vertical line 606. The second scatterplot 604 can reside to the right of the vertical line 606. A first regression line, average, or other statistical measurement 608 can be created based on the first scatterplot 602. A portion of the first regression line, average, or other statistical measurement 608 extending beyond the vertical line 606 can represent expected engine performance in the absence of the engine wash event. A second regression line, average, or other statistical measurement 610 can be created based on the second scatterplot 604. A difference between the second regression line, average, or other statistical measurement 610 and the first regression line, average, or other statistical measurement 608 can represent an improvement in engine performance attributable to the engine wash event. A horizontal line 612 can be drawn to the right of the intersection of the vertical line 606 and the first regression line, average, or other statistical measurement 608. A triangle can be formed from the vertical line 606, the second regression line, average, or other statistical measurement 610, and the horizontal line 612. In an aspect, the triangle can represent an improvement in engine performance attributable to the engine wash event.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system comprising:
one or more memory devices; and
one or more processors configured to:
receive first parameters related to engine performance prior to an engine wash event;
receive second parameters related to engine performance after the engine wash event;
determine an engine performance prior to the engine wash event based on the first parameters;
determine an engine performance after the engine wash event based on the second parameters; and
determine an effectiveness of the engine wash event based on the engine performance prior to the engine wash event and the engine performance after the engine wash event.

2. The system of claim 1, wherein the one or more processors are further configured to:
receive third parameters related to engine performance prior to a second engine wash event;
receive fourth parameters related to engine performance after the second engine wash event;
determine an engine performance prior to the second engine wash event based on the third parameters;
determine an engine performance after the second engine wash event based on the fourth parameters; and
determine an effectiveness of the second engine wash event based on the engine performance prior to the second engine wash event and the engine performance after the second engine wash event.

3. The system of claim 2, wherein the one or more processors are further configured to model the effectiveness of engine wash events based, at least in part, on the effectiveness of the first engine wash event and the effectiveness of the second engine wash event.

4. The system of claim 2, wherein the one or more processors are further configured to model the effectiveness of engine wash events based, at least in part, on the effectiveness of the first engine wash event.

5. The system of claim 4 wherein the one or more processors are further configured to revise the model based, at least in part, on the effectiveness of the second engine wash event.

6. The system of claim 1, wherein the one or more processors are further configured to receive one or more engine wash event attributes.

7. The system of claim 6, wherein determining an effectiveness of the engine wash event further comprises categorizing the engine wash event into at least one category based, at least in part, on the one or more engine wash event attributes.

8. The system of claim 7, wherein the one or more engine wash event attributes comprise one or more of the following: a wash date, a wash time, a wash station, a washer, a washer skill level, a worker experience level, a worker training level, a number of washers, an engine, a fleet, a number of wash cycles, a total dissolved solvents measurement at each cycle, a total suspended solvents measurement at each cycle, a number of rinses, a total dissolved solids, or an equipment type.

9. The system of claim 1, wherein determining an engine performance prior to the engine wash event based on the first parameters further comprises generating a first regression line based on a first scatter plot, wherein one or more of the first parameters are used to create at least one point in the first scatter plot.

10. The system of claim 9, wherein determining an engine performance after the engine wash event based on the second parameters further comprises generating a second regression line based on a second scatter plot, wherein one or more of the second parameters are used to create at least one point in the second scatter plot.

11. The system of claim 10, wherein determining an effectiveness of the engine wash event further comprises comparing the first regression line with the second regression line.

12. The system of claim 9, wherein generating a first regression line based on a first scatter plot further comprises removing one or more outlier points from the first scatter plot.

13. The system of claim 1, wherein the first parameters comprises at least one of:
an Exhaust Gas Temperature, an Exhaust Gas Temperature Hot Day Margin, fuel burn, or modular efficiency.

14. A method for measuring engine performance comprising:
receiving, by one or more computing devices, first parameters related to engine performance prior to an engine wash event;
receiving, by the one or more computing devices, second parameters related to engine performance after the engine wash event;
determining, by the one or more computing devices, an engine performance prior to the engine wash event based on the first parameters;
determining, by the one or more computing devices, an engine performance after the engine wash event based on the second parameters; and
determining, by the one or more computing devices, an effectiveness of the engine wash event based on the engine performance prior to the engine wash event and the engine performance after the engine wash event.

15. The method of claim 14, comprising:
receiving, by the one or more computing devices, third parameters related to engine performance prior to a second engine wash event;
receiving, by the one or more computing devices, fourth parameters related to engine performance after the second engine wash event;
determining, by the one or more computing devices, an engine performance prior to the second engine wash event based on the third parameters;
determining, by the one or more computing devices, an engine performance after the second engine wash event based on the fourth parameters; and
determining, by the one or more computing devices, an effectiveness of the second engine wash event based on the engine performance prior to the second engine wash event and the engine performance after the second engine wash event.

16. The method of claim 15, further comprising modeling the effectiveness of engine wash events based, at least in part, on the effectiveness of the first engine wash event and the effectiveness of the second engine wash event.

17. The method of claim 15, further comprising modeling the effectiveness of engine wash events based, at least in part, on the effectiveness of the first engine wash event.

18. The method of claim 17, further comprising revising the model based, at least in part, on the effectiveness of the second engine wash event.

19. The method of claim 14, further comprising receiving one or more engine wash event attributes.

20. An aerial vehicle comprising:
one or more memory devices; and
one or more processors configured to:
receive first parameters related to engine performance prior to an engine wash event;
receive second parameters related to engine performance after the engine wash event;
determine an engine performance prior to the engine wash event based on the first parameters;
determine an engine performance after the engine wash event based on the second parameters; and
determine an effectiveness of the engine wash event based on the engine performance prior to the engine wash event and the engine performance after the engine wash event.
